(19) United States
(12) Patent Application Publication
(10) Pub. No.: US 2017/0348173 A1
(43) Pub. Date: Dec. 7, 2017

(54) SURGICAL SUPPORT AND COVER THEREFOR

(71) Applicant: EC MEDICA LTD, Southport (Merseyside) (GB)

(72) Inventor: Paul BENNETTS, Southport (Merseyside) (GB)

(21) Appl. No.: 15/539,139

(22) PCT Filed: Dec. 22, 2015
(86) PCT No.: PCT/GB2015/054131

§ 371 Date: Jun. 22, 2017

(30) Foreign Application Priority Data
Dec. 22, 2014 (GB) 1422932.2
Mar. 9, 2015 (GB) 1503983.7

(51) Int. Cl. A61G 13/12

(52) U.S. Cl. CPC A61G 13/126; A61G 13/1285

(57) ABSTRACT

The invention relates to a surgical support (20) having a base (22) which is ergonomically shaped to support a part of a patient's anatomy and a removable cover (24) which has an inner surface (30) and an outer surface (32) and which is adapted to fit over the base with its inner surface toward the base. The cover carries a cushioning pad (34) which preferably comprises memory foam and is secured to the outer surface of the cover and positioned to be interposed between the patient and the base in use. The relatively bulky base can be used multiple times. The cover and its cushioning pad are easily replaced.

The present invention relates to a surgical support for positioning and cushioning part of a patient's anatomy.

Supports are widely used in surgery to position and maintain a particular part of the patient's anatomy. This may involve supporting a chosen part of the body stably, as where a headrest is used to raise the head and maintain its orientation, or maintaining a certain bodily configuration, as where a support placed beneath the torso of a prone patient is used to provide convex curvature of the spine in order to facilitate spinal surgery.

By their nature such supports exert pressure on the body. Prolonged use can lead to complications such as pressure sores. To ameliorate this, surgical supports are provided with cushioning. One known type of surgical support uses a base part of rubber foam to form the support's gross shape and a layer of memory foam moulded on the base part to provide cushioning. The memory foam is able to deform to accommodate the shape of the supported body part and so helps to distribute pressure more evenly over it. The relatively stiff base maintains the supports overall shape and so ensures a degree of stability. For best effect the memory foam is in contact with the patient's skin—this helps to avoid pressure sores and accumulation of sweat. Further, if the memory foam is covered, for example, by a textile cover, this can sometimes inhibit lateral spreading of the surface of the memory foam when pressure is applied, thereby rendering it non-conformal, or not as-conformal as may be needed. Typically, therefore, no cover is used and such supports thus need to be discarded and replaced after a single use for the sake of hygiene and safety.

A hospital or operating theatre thus needs a considerable inventory of supports. They are bulky items and there are consequent expense, inconvenience and undesirable environmental implications in their manufacture, transportation, storage and disposal.

Various aspects of the invention are set forth in the appendant claims.

In accordance with a first aspect of the present invention, there is a surgical support comprising a base shaped to support a part of a patient's anatomy, a removable cover which has an inner surface and an outer surface and is adapted to fit over the base with its inner surface toward the base, and a cushioning pad secured at the outer surface of the cover and positioned to be interposed between the patient and the base in use.

According to another aspect of the invention, there is provided a surgical support comprising a base shaped to support a part of a patient's anatomy, a removable cover which has an inner surface and an outer surface and is adapted to fit over the base with its inner surface toward the base, and a cushioning pad manufactured of memory foam secured to the outer surface of the cover, the cushioning pad being positioned to be interposed between the patient and the cover in use

By virtue of the present invention, the pad is in direct contact with the patient, to provide the required cushioning and protection, because it is at the outer surface of the removable cover. The cover and pad can be disposable items but because the relatively bulky base does not need to be replaced after each use the problems of cost, storage and disposal are greatly reduced.

In accordance with another aspect of the present invention there is a cover for a surgical support, the cover comprising flexible sheet material for fitting over a base of the surgical support, the sheet material having an inner surface for placement against the base and an outer surface, and a cushioning pad secured at the outer surface of the cover.

In accordance with another aspect of the present invention there is a cover for a surgical support, the cover comprising flexible sheet material for fitting over a base of the surgical support, the sheet material having an inner surface for placement against the base and an outer surface, and a memory foam cushioning pad secured at the outer surface of the cover.

In certain embodiments the cushioning pad comprises memory foam.

The cover may comprise flexible sheet material. It may be provided with a retainer arrangement for retaining the cover in place upon the base in use. The retainer arrangement may comprise elastic or a drawstring extending around at least part of the cover's periphery. The cover may comprise a textile material.

Moulded rubber foam is a suitable material for the base, although other materials could be selected. In certain embodiments the base provides a support surface for supporting the part of the patient's anatomy and the pad of foam is shaped to complement the support surface.

The surgical support is typically to be placed upon an operating table in use and to that end, in certain embodiments, comprises an underside adapted to rest stably on a table. The underside of the base may be substantially flat.

Specific embodiments of the present invention will now be described, by way of example only, with reference to the accompanying drawings, in which:—

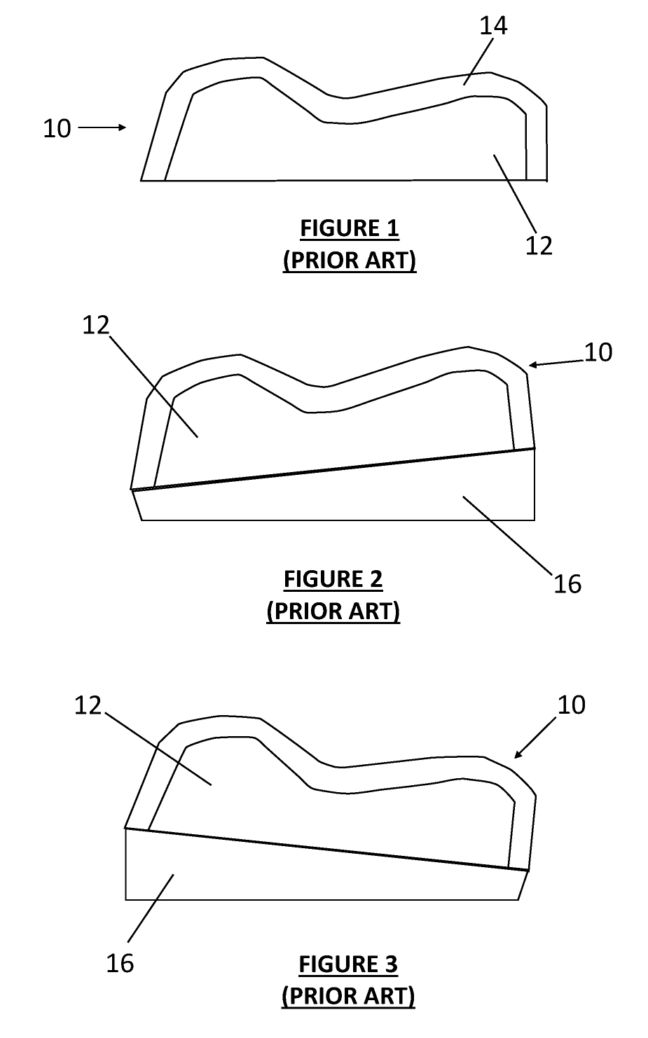

FIGS. 1 to 3 are each sectional views, taken in a longitudinal plane, of a surgical support of known type;

FIGS. 3 to 6 are each sectional views, taken in a longitudinal plane, of a surgical support embodying the present invention;

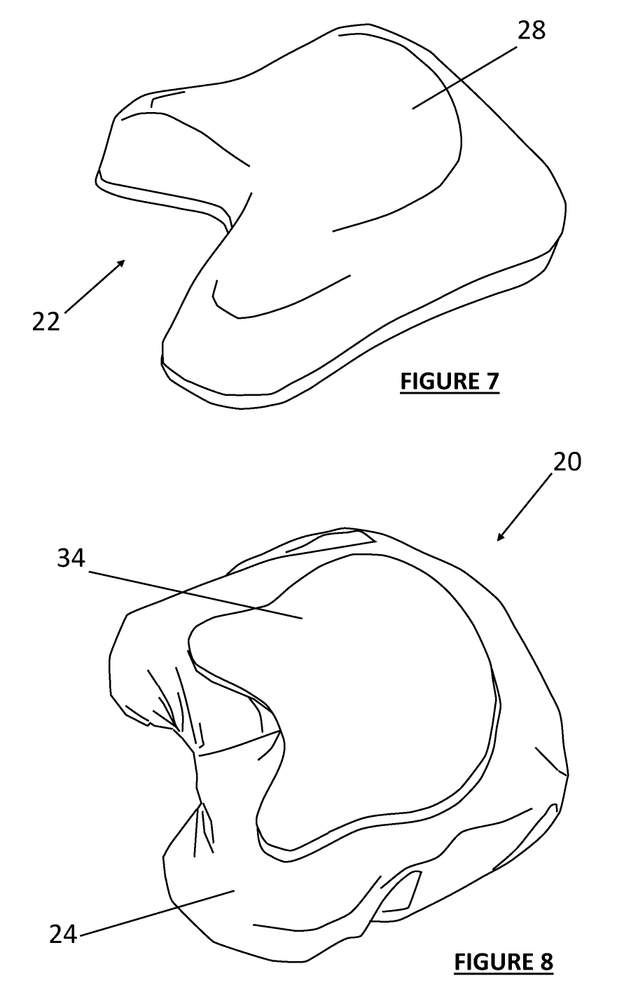

FIG. 7 represents a base of the surgical support of FIGS. 3 to 6 viewed from above and to one side, a cover being omitted;

FIG. 8 is similar to FIG. 7 but shows the surgical support with the cover in place; and

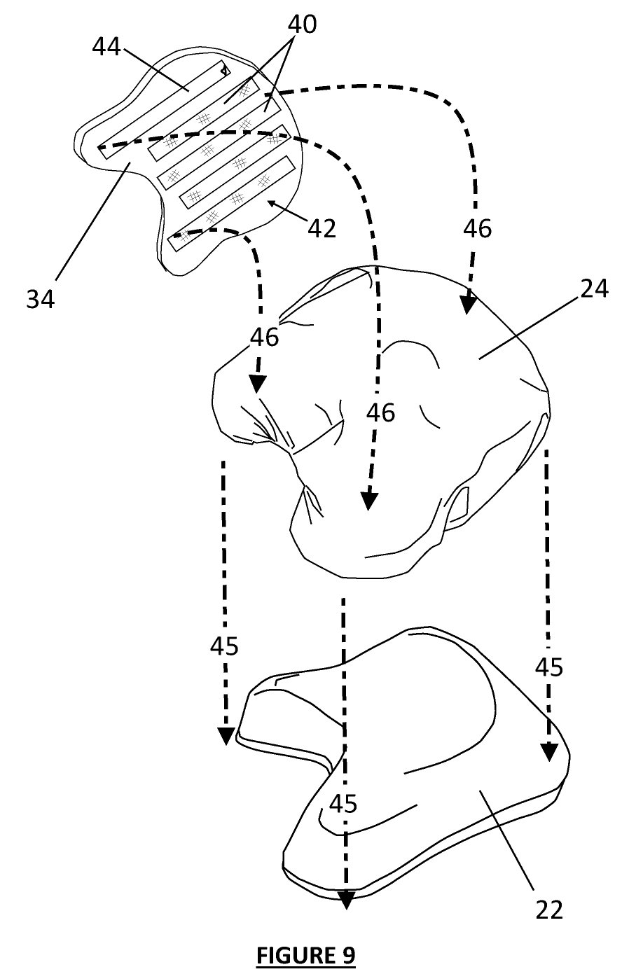

FIG. 9 shows an alternative embodiment of the invention in kit form.

The surgical support 10 represented in FIGS. 1 to 3 belongs to the prior art. It comprises an ergonomically shaped base 12 which forms the gross shape of the support. In this example the base 12 is moulded from rubber foam rigid enough to substantially maintain its shape in use. The base 12 has an upper face which supports a part of the patient's body in use and this face is covered by a layer of memory foam 14, which serves to cushion the patient's body and help to distribute pressure over it. The surgical support 10 may for example be placed upon the operating table during an operation to maintain the patient in a desired position. The example illustrated is a head support. It can be placed upon an operating table to maintain the head's position. In some cases it may be desirable to alter the inclination of the surgical support 10 and FIGS. 2 and 3 show an optional wedge 16 for this purpose, placed beneath the base 12.

The memory foam 14 is permanently secured to the base 12. For the reasons explained above, the known surgical support 10 is a single use item.

The surgical support 20 represented in FIGS. 3 to 8 embodies the present invention. It comprises an ergonomically shaped base 22 which once more defines the gross shape of the support and is sufficiently rigid to substantially maintain its shape under the weight of the supported body part. The base 22 may be moulded from rubber foam or other suitable material. Its underside 23 is adapted to rest upon a supporting table such as an operating table, being flat in the illustrated embodiment.

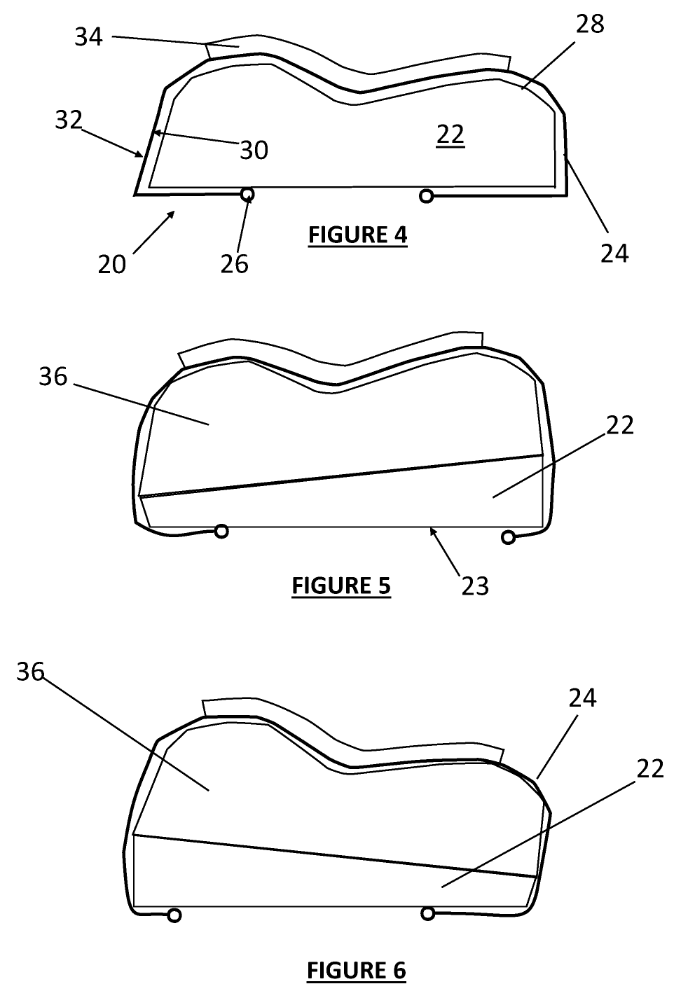

Carried upon the base 22 is a cover 24 comprising flexible sheet material. The particular sheet material used may be chosen according to specific requirements but textiles are suitable. The cover 24 may be impermeable to fluids, to resist contamination of the base 22 with bodily fluids and other matter, but in the illustrated embodiment it is made of porous textile. An arrangement is provided for retaining the cover 24 on the base 22. In the illustrated embodiment this takes the form of an elasticated hem or drawstring which extends around the cover's periphery and is schematically represented at 26 in FIGS. 4 to 6. The cover 24 overlies the entirety of support surface 28 of the base 22 and thus prevents direct contact of the patient with the base 22 in use. It also extends beneath the support so that by drawing the cover's periphery together the drawstring or elasticated hem 26 keeps the cover in place in use, although it can easily be removed thereafter.

The cover 24 has an inner surface 30 which, in use, faces toward and contacts the base 22. It also has an outer surface 32 upon which is carried a pad 34 of memory foam.

The memory foam, in a preferred embodiment of the invention, comprises combustion Modified Polyurethane visco-elastic foam (grade VE50/055), having a density of 48-52 kgm^{-'}and a hardness of 46-64 N.

The pad 34 may take various forms according to the specific purpose of the surgical support 20. In the illustrated example it comprises a pad which is initially flat but which conforms to the shape of the support surface 28 under the weight of the supported body part. The pad 34 could instead be pre-formed to match the contours of the base 22. The pad 34 covers only part of the support surface 28 in this embodiment but in others it may cover the entirety of the support surface. The plan shape of the pad 34 complements the shape of the base 22 and its position is such that the pad 34 is interposed between the supported part of the patient's anatomy and the base in use, to provide the desired cushioning effect.

Memory foam has particularly advantageous properties. It is able to deform under pressure, shaping itself to a supported body part and so distributing pressure over it, and following removal of the pressure it recovers its original shape over a period of time—a property sometimes referred to as “viscoelasticity”. Known polyurethane memory foam, especially low resilience polyurethane foam (LRPu) may be used in the present invention. Some memory foams are able to deform permanently or semi-permanently subject to body pressure and heat and these too may be used in embodiments of the invention.

An advantage of interposing the memory foam pad 34 between the patient and the cover 24 is that the patient is (or can be) placed in direct contact with the memory foam. Thus, the memory foam pad 34 can act as an absorbent layer, to help keep the patient's skin and/or hair dry (or drier) over prolonged periods of use. This configuration is generally contraindicated by conventional wisdom in the art whereby possible adhesion of the body to the pad is to be avoided (for example, by clotted blood).

However, surprisingly, the advantages of having the patient in direct contact with the memory foam pad greatly outweigh the possible disadvantage of adhesion. Specifically, by placing the patient's skin/body/hair in direct contact with the memory foam pad, the memory foam pad's surface is able to deform in various directions, such as in the direction of the thickness of the pad, as well as laterally i.e. spread or compress in the plane of the pad. This has been found to give rise to improved conformity of the pad with the patient's anatomy, as well as reducing and/or avoiding wrinkling of the pad and/or patient's skin, which may otherwise lead to pinching, skin creases, pressure sores and the like. Further, the possibility of a wrinkled cover coming into contact with the patient's skin is also avoided by the placement of the memory foam pad between the patient and the cover, as required by embodiments of the invention.

Thus, the invention is contraindicated according to overwhelmingly accepted theatre practices. However, the perceived disadvantages and contraindications of placing the memory foam pad in contact with the patient's skin have been found, in many cases, to be over-stated, whereas the advantages of the invention (placing the memory foam in contact with the patient's skin) have been found to more than outweigh any possible disadvantages.

A further embodiment of the invention, in kit form, is shown in FIG. 9 of the drawings in which the cover 24 and memory foam pad 34 are supplied as separate items. This configuration facilitates attaching the cover 24 to the base 22 because it is not necessary, whilst attaching the cover 24, to correctly align the pad 34 with the base. Thus, in use, the base 24 can be covered 45 with the cover 24, and positioned on the operating table as required. The memory foam pad 34 can then be affixed to the exterior surface of the cover 24, for example suing self-adhesive strips 40. In the illustrated embodiment, the self-adhesive strips 40 are provided in substantially parallel rows on the back face 42 of the memory foam pad 34, although any configuration or orientation of self-adhesive strip or strips 4 could be used. The or each self-adhesive strip 40 comprises a pressure-sensitive adhesive layer that adheres to the exterior surface of the cover 24. Prior to use, the or each self-adhesive strip 40 is protected by a peel-off layer 44 to prevent the pad 34 from inadvertently sticking to objects prior to use. The peel-off layers 44 are removed immediately prior to use, then the pad 34 is placed 46 over the cover 24 in a desired position and pressed down to secure the pad 34 to the cover 24. Some subsequent adjustment may be achieved by moving the cover 24 relative to the base 22, but this may not always be necessary.

Various advantages arise from providing the invention in kit form, such as reduced manufacturing cost (cost savings can be passed onto hospitals); the ability to mix-and-match different covers 24 with different pads 34; reduced set-up time as the pad 34 can be placed after the base 22 and cover 24 have been positioned; and improved conformity because the pad can be used to overlie/mask any creases in the cover 24, rather than possibly puckering the pad, as might otherwise be the case.

The kit-form embodiment of the invention is suitably supplied to end users in a sealed and/or hermetically-sealed bag containing one or more covers and one or more pads.

The present invention is applicable to supports for many parts of the anatomy—head supports, torso supports, foot supports, leg supports and so on—and accordingly the shape of the base 22 and of the pad 34 may differ altogether from the embodiment represented herein. The base 22 of FIG. 4 is formed by a single moulding, but in other embodiments it may be comprise two or more parts. FIGS. 5 and 6 show an example, having a wedge 36 placed beneath the main part of the base 22 to change its inclination. The cover 24—which is a loose fit—is able to accommodate and cover both the main base part 22 and the wedge 36. It can assist in maintaining the relative positions of the base 22 and the wedge 36, resisting the natural tendency of the base 22 to slip down the inclined upper surface of the wedge. The base may have other removable parts. For example a chest support for a prone patient may have removable portions to accommodate the bust of a female patient, enabling it to be used with patients of either gender. Also the support may be shaped and proportioned for use with children. While its principal intended use relates to human patients, there is no reason why it should not be adopted for treatment of animals and the word “patient” may be correspondingly construed.

The cover 24 (including its pad 34) can be disposable items intended for a single use only. The base 22, however, can by virtue of the present invention be used multiple times. Thus only a relatively small inventory of the bulky base 22 need be maintained. This reduces purchase costs and storage requirements, since the covers 24 can be relatively cheap and compact. Also where the cushioning of memory foam is not required the base 22 can be used without padding, to further reduce inventory and cost.

The following statements are not the claims, but relate to various possible features and/or embodiments of the invention:
Statement 1. A cover for a surgical support, the cover comprising flexible sheet material for fitting over a base of the surgical support, the sheet material having an inner surface for placement against the base and an outer surface, and a memory foam cushioning pad secured, in use, to the outer surface of the cover such that, in use, the cover is interposed between the base and the cushioning pad.
Statement 2. The cover of statement 1, further comprising self-adhesive means interposed between the memory foam cushioning pad and the outer surface of the cover.
Statement 3. The cover of statement 2, wherein the self-adhesive means comprises one or more strips of pressure-sensitive self-adhesive.
Statement 4. The cover of statement 2 or statement 3, wherein the self-adhesive means comprises a double-sided pressure-sensitive self-adhesive strip affixed on a first side to the memory foam cushioning pad and on a second side to a peel-away protective layer, the peel-away protective layer being removable prior to use to expose the second side for affixing memory foam cushioning pad to the cover.
Statement 5. The cover of statement 2 or statement 3, wherein the self-adhesive means comprises a double-sided pressure-sensitive self-adhesive strip affixed on a first side to the cover and on a second side to a peel-away protective layer, the peel-away protective layer being removable prior to use to expose the second side for affixing cover to the memory foam cushioning pad.
Statement 6. The cover of any preceding statement, further comprising a retainer arrangement for retaining the cover in place upon the base in use.
Statement 7. The cover of statement 6 in which the retainer arrangement comprises elastic or a drawstring extending around at least part of the cover's periphery.
Statement 8. The cover of any preceding statement, in which the flexible sheet material comprises a textile.
Statement 9. A surgical support comprising a base shaped to support a part of a patient's anatomy, and a removable cover according to any preceding statement, the removable cover comprising an inner surface and an outer surface and is adapted to fit over the base with its inner surface toward the base, and wherein the memory foam cushioning pad is secured, in use, to the outer surface of the cover, the cushioning pad being positioned to be interposed, in use, between a patient and the cover.
Statement 10. A cover or surgical support according to any preceding statement, wherein the memory foam comprises combustion modified polyurethane visco-elastic foam.
Statement 11. A cover or surgical support according to any preceding statement, wherein the memory foam has a density of substantially 48-52 kgm⁻³.
Statement 12. A cover or surgical support according to any preceding statement, wherein the memory foam has a hardness of substantially 46-64 N.
Statement 13. The surgical support of any of statements 9 to 12, in which the base comprises moulded rubber foam.
Statement 14. The surgical support of any of statements 9 to 13, in which the base provides a support surface for supporting the part of the patient's anatomy and the pad of foam is shaped to complement the support surface.
Statement 15. The surgical support of any of statements 9 to 14, which has an underside adapted to rest stably on a table.
Statement 16. The surgical support of statement 15, in which the underside of the base is substantially flat.
Statement 17. A kit comprising cover, and memory foam cushioning pad according to any of statements 1 to 8.
Statement 18. The kit of statement 17, further comprising a base according to any of statements 9 and 13 to 16.
Statement 19. The kit of statement 17 or statement 18, further comprising a sealed outer bag for sealingly enclosing the cover and memory foam cushioning pad prior to use.
Statement 20. A surgical support substantially as herein described with reference to, and as illustrated in, accompanying FIGS. 4 to 9.
Statement 21. A cover for a surgical support substantially as herein described with reference to, and as illustrated in, accompanying FIGS. 4 to 9.

1-21. (canceled)

22. A cover for a surgical support, the cover comprising:
flexible sheet material for fitting, in use, over a base of a surgical support; and
an elastic or drawstring retainer arrangement extending around at least part of the periphery of the cover for retaining the cover in place upon the base in use,
the sheet material having an inner surface for placement, in use, against the base and an outer surface,
wherein the cover further comprises a memory foam cushioning pad secured at the outer surface of the cover such that the memory foam of the memory foam cushioning pad is interposed, in use, between a patient and the base, and such that the memory foam of the memory foam cushioning pad contacts the patient directly in use.

23. The cover of claim 22, wherein the flexible sheet material comprises a textile material.

24. The cover of claim 22, wherein the memory foam comprises combustion modified polyurethane visco-elastic foam.

25. The cover of claim 22, wherein the memory foam has a density in a range of 48 to 52 kgm⁻³.

26. The cover of claim 22, wherein the memory foam has a hardness in a range of 46-64 N.

27. The cover of claim 22, wherein the memory foam cushioning pad of the cover is shaped to complement the surgical support.

28. The cover of claim 22, wherein the memory foam pad is affixed to the exterior surface of the cover by self-adhesive strips.

29. The cover of claim 28, wherein the self-adhesive strips are provided in substantially parallel rows on a back face of the memory foam pad.

30. The cover of claim 28, wherein at least one self-adhesive strip comprises a pressure-sensitive adhesive layer that adheres to the exterior surface of the cover.

31. A surgical support comprising:
a base shaped to support a part of a patient's anatomy; and
a cover comprising:
flexible sheet material for fitting, in use, over a base of the surgical support, and
an elastic or drawstring retainer arrangement extending around at least part of the cover's periphery for retaining the cover in place upon the base in use,
the sheet material having an inner surface for placement, in use, against the base and an outer surface,
wherein the cover further comprises a memory foam cushioning pad secured at the outer surface of the cover;
the cover being fitted to the base with its inner surface toward the base, and the memory foam cushioning pad positioned, in use, to be interposed between the patient and the base such that the memory foam of the memory foam cushioning pad contacts the patient directly in use.

32. The surgical support of claim 31, wherein the base comprises moulded rubber foam.

33. The surgical support of claim 31, wherein the base provides a support surface for supporting the part of the patient's anatomy.

34. The surgical support of claim 31, wherein the part of the patient's anatomy comprises any one or more of the group comprising: a patient's head; a patient's torso; a patient's leg; and a patient's foot.

35. The surgical support of claim 31, wherein the memory foam cushioning pad of the cover is shaped to complement the support surface.

36. The surgical support of claim 31, wherein the base has an underside adapted to rest stably on a table.

37. The surgical support of claim 36, wherein the underside of the base is substantially flat.
